(19) United States
(12) Patent Application Publication
(10) Pub. No.: US 2008/0165045 A1
(43) Pub. Date: Jul. 10, 2008

(54) System and Method for Message Processing and Generation of Multimedia Content Remotely Controlled

(76) Inventors: Milos Cvetanovic, Belgrade (YU); Jovan Maric, Belgrade (YU)

Correspondence Address: ABELMAN, FRAYNE & SCHWAB, 666 THIRD AVENUE, 10TH FLOOR, NEW YORK, NY, 10017, US

(21) Appl. No.: 11/813,197

(22) PCT Filed: Dec. 29, 2005
(86) PCT No.: PCT/YU2005/000034

§ 371 Date: Jun. 29, 2007

(30) Foreign Application Priority Data
Dec. 31, 2004 (YU) P-1166/04

(51) Int. Cl. H04N 7/16; G08C 19/00; H04L 17/02

(52) U.S. Cl. 341/176

(57) ABSTRACT

Messages such as short message service (SMS) and multimedia messaging service (MMS) reach a GVB device for message processing and multimedia content generation through the infrastructure of a mobile provider. Depending on the message content and sender, the GVB device processes messages and generates an appropriate signal for the presentation on a display device. The GVB device is able to display text, image and video material from its internal memory. The internal memory could be updated by a general packet radio service (GPRS), the Internet, an Ethernet system, etc. The generated multimedia content could be optionally mixed with, or displayed over, an input signal. If necessary, the GVB device could be centrally controlled, and then it is possible to present multimedia content selectively to target groups,

### CROSS-REFERENCE TO RELATED APPLICATIONS

This application is a 371 of international application number PCT/YU2005/000034, filed on Dec. 29, 2005.

### BACKGROUND OF THE INVENTION

1. FIELD OF THE INVENTION

The present invention relates to a system and method for processing messages received through the infrastructure of telephone companies (land line and mobile) or the Internet, generating multimedia and advertising content and projecting it on a display device.

2. DESCRIPTION OF THE RELATED ART

Increased needs for marketing services have resulted in a problem of updating and distributing marketing materials, with added constraints of a limited time, and distant geographical locations. Most existing advertising methods limit interactions with an end user. A solution to this problem is further described herein as an invention based on the current information technologies and telecommunications infrastructure. The described approach enables selected multimedia material to be presented to specific target groups.

In the prior art, there is no known system, device and method, for performing the mentioned manner of information and advertising content distribution to an end user or to a target group of users, with the possibility of interactivity. One similar method is disclosed in the U.S. Pat. No. 5,754,172 entitled “Information display method”. The purpose of this method is to enable the end user to choose desired information which will be displayed on screen. The user with his interactions influences the order and genre of the information that he wants to see. The material to be displayed is sent incorporated into an existing satellite television signal. The infrastructure of mobile telephony is not used as a communication channel.

In the International Classification group H04N7/025D, in the system published as WO 9835499 entitled “System For Displaying Information” a method for displaying information simultaneously on one or more screens is described, not mentioning the manner of data distribution or the possibility of interaction with a user through a mobile telephony infrastructure. Also, the system does not deal with the problem of updating, memorizing and generating the content for displaying purposes.

WO 9856181 entitled “System at Telecommunications Network” describes a system that only provides the possibility of selecting a broadband service to an end user. In this case, the end user chooses the information or service which he wants to receive.

WO 03/077550 A1 entitled “A System and Method for Transferring an MMS between Message Communication Unit and Digital TV” describes a method for transferring MMS messages through the infrastructure of a cable, satellite or radio frequency (RF) television, but without the possibility of interaction.

WO 0013415 entitled “Television Message System” describes a system for two way textual communication between individual television subscribers, neither mentioning possibility of multimedia content displaying nor covering the aspects of content generation.

From the described patents and patent applications of the prior art, it is obvious that a system, i.e. device and method, that controls the generation and displaying of multimedia content using messages while enabling an appropriate level of interactivity with an end user, does not exists.

### BRIEF SUMMARY OF THE INVENTION

The purpose of this invention is to provide a system and method which would enable both easy and fast distribution of information and multimedia content to the target group of people or devices. The device described herein and used to implement the system and method of the present invention is referred to as a “GVB device” herein. It receives and processes messages and generates multimedia content. It is remotely controlled. Multimedia content is defined herein to include text, an image, a set of images, video material, a set of video materials, an audio recording, a set of audio recordings or any other combination of the mentioned elements. A target group is defined herein as a group of people able to receive information, that is, to see or hear the multimedia content generated by a GVB device and shown on a display device. A display device is defined herein as including a projector such as a video beam projector, a television (TV), a device for audio reproduction, a plasma screen, a monitor, a holographic display, a segmented display, a light emitting diode (LED) display, or an organic LED (OLED) display, which could be standalone or part of an advertising billboard. The GVB device could be standalone or part of a display device.

The process of multimedia and information content distribution is controlled through a telecommunications infrastructure that includes the infrastructure of a mobile provider, the Internet, land line telephony, an Ethernet system, a wireless network and similar known infrastructures. Sending or updating the content of the GVB device is done when necessary or during off peak traffic hours.

Multimedia content can be displayed at will at any moment, according to a specific schedule, initiated by a corresponding command message or triggered by an input signal. Depending on the content or sender of the message, the GVB device processes messages and generates the appropriate signal that would be shown on the display device.

The GVB device can display text, images, and video materials from its own memory with the possibility of generating them according to received command messages. Also, optionally, the generated multimedia content could be mixed with the input video signal, i.e. displayed over it.

The purpose of this invention is further accomplished with a method having two aspects. From the first aspect, one GVB device and one display device are used as a standalone configuration. The method in this way consists of the following steps:
a) the destination GVB device receives a command message,
b) the GVB device analyses and processes the received message, and
c) depending on the sender and content of the message, the GVB device generates a signal for the display device upon which the appropriate presentation is generated.

If it is necessary to synchronize or simultaneously control several GVB devices, centralization can be achieved by using a server part or a command center which is called “HQ” herein and as shown in the drawings in accordance with the second aspect of the present invention. In that case, the method consists of the following steps:
a) the EQ generates and sends a command message to the destination GVB device,
b) the destination GVB device receives the command messages,
c) the GVB device analyses and processes the received messages, and
d) depending on the sender and content of the message, the GVB device generates a signal for the display device upon which the appropriate presentation is generated.

In case of centralized usage, the processing part done by some of the GVB devices could be done centrally by the HQ, thus unburdening the individual GVB devices. The EQ could be also used in cases where there is only one GVB device present in the system.

According to both described aspects of this method, a complete system for the realization of the purpose of the invention consists of:
a) the GVB device, which is a device with the following functions: reception of command messages, their decoding, analyzing, and processing, generation of an output signal based on the internal memory processing, mixing the generated signal with an input signal, interaction with the user in order to configure the device, and updating the content of the internal memory;
b) a display device that could be a:

projector (video beam), TV set, device for audio reproduction, plasma screen, monitor such as a cathode ray tube (CRT) or a thin film transistor (TFT) display device, holographic display, or segmented, LED or OLED display which could be standalone or part of an advertising billboard, but is not exclusively limited to the above mentioned elements;
c) optional source of the input signal that could be mixed with the generated signal which is the source of a video signal that could be a modulated signal, a signal in a base 10 spectrum, or a signal in any format including super video home system (SVHS), composite, red- green-blue (RGB), TV antenna signal, video graphics array (VGA), digital visual interface (DVI), or IEEE 1394, but is not exclusively limited to the mentioned signals;
d) an HQ, in accordance with the second aspect of the described method, with the following functions: generation of command messages destined for the destination GVB devices, updating the content of the destination GVB device or group of devices, and communication with the target group and processing the received information;
e) existing telecommunications infrastructure that could be:

an infrastructure of a mobile telephony provider, the Internet, a telephony infrastructure, an Ethernet system, or 208,959
a wireless network such as an IEEE 802.11 network, but is not exclusively limited to any one of them.

A possible application of the described system and method is the possibility that the end user of the information, received through the Global System for Mobile communications (GSM) messages or other mentioned options, can send back the responding information which could be used for market research purposes.

The GVB device can analyze the optional input signal in case that such a signal is present.

### BRIEF DESCRIPTION OF THE SEVERAL VIEWS OF THE DRAWINGS

The described system and method as well as their additional features and advantages over the existing inventions are explained in more details in the accompanying drawings:

FIG. 1A and FIG. 1B are schematic representations of the system functioning according to this invention, utilizing an existing telecommunications infrastructure. FIG. 1A shows a GVB device and a display device as a standalone configuration used in accordance with the first aspect of the presented method. FIG. 1B shows several GVB devices incorporated in a whole, centrally controlled by an HQ), in accordance with the second aspect of the presented method.

FIG. 2 shows a functional scheme of a GVB device incorporating interfaces between it and the rest of the system.

FIG. 3 shows an activity block diagram of a GVB device used without HQ.

FIG. 4A shows an activity block diagram of the system with central control from the aspect of an HQ.

FIG. 4B shows an activity block diagram of the system with central control from the aspect of a GVB device.

FIG. 5A and FIG. 5B show activity block diagrams of the process of GVB content update, in which FIG. 5A shows the process from the GVB perspective, and FIG. 5B from the HQ perspective.

### DETAILED DESCRIPTION OF THE INVENTION

The present invention is related to international application number PCT/YU2005/000034, filed on Dec. 29, 2005, which is incorporated herein by reference in its entirety.

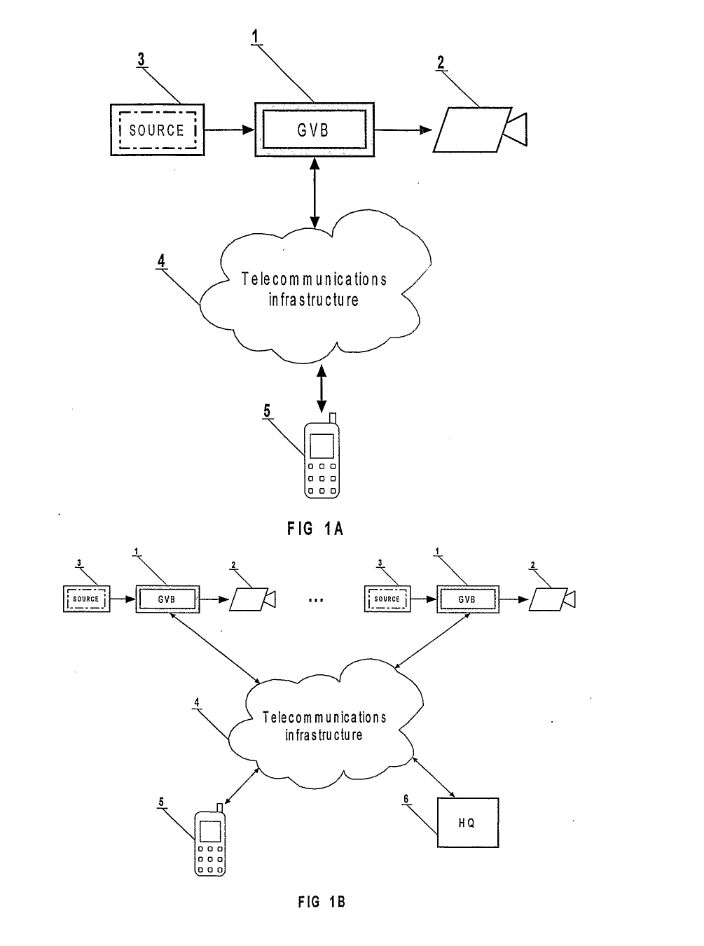

As previously stated, this invention has two aspects. For the realization of both aspects a remotely controlled system that would process messages and generate multimedia content is needed. With reference to FIG. 1A and FIG. 1B, the system includes:
a. at least one GVB device 1 which receives, decodes, analyses and processes messages by means of which it generates multimedia content to be displayed on a display device 2, where the GVB device 1 could be standalone or integrated in (part of the display device 2 and could be uniquely identified on a telecommunications infrastructure 4,
b. at least one display device 2 for presentation of the multimedia content generated by the GVB device 1,
c. the existing telecommunications infrastructure 4 designed for transferring messages to and from the GVB device 1 and transferring information required for the GVB device 1 memory content updating,
d. a device 5 which has a possibility of interconnecting with the existing telecommunications infrastructure 4 with the purpose of sending messages to the GVB device 1 or to an HQ 6,
e. optionally, an HQ 6 connected to the telecommunications infrastructure 4 in case that there is at least one GVB device 1 which is centrally controlled by the HQ 6, and
f. optionally, at least one source 3 of an input signal to at least one GVB device 1 for generating and updating the GVB device 1 memory content.

The system according to the present invention, illustrated in FIG. 1A represents a basic embodiment of the first aspect of this invention that makes it possible to generate multimedia content from the GVB device 1 and present it on the display device 2. The generation and presentation of multimedia content could be initiated and controlled by means of command messages received by the GVB device 1 through the existing telecommunications infrastructure 4. The command messages are sent from the device 5 which could be a cellular phone or a device with the proper interface between it and the telecommunications infrastructure 4.

During the generation of multimedia content the GVB device I can mix the generated signal with, i.e. display over, the input video signal from the source 3. The generation and presentation of the previously defined multimedia content could be initiated from the source 3 or by an internal real time clock.

In accordance with the second aspect of the present invention, a system illustrated in FIG. 1B represents the second version of GVB device 1 usage. In this case there are several GVB devices I which are centrally controlled by the HQ 6. As previously stated, the HQ 6 is a server or a central command center which consists of one or more interconnected computers with an appropriate application software, which remotely control the GVB devices I through the telecommunications infrastructure 4. The GVB device I receives the command messages sent by the HQ 6 through the telecommunications infrastructure 4. The existing telecommunications infrastructure 4 could be the infrastructure of a mobile provider, the Internet, land line telephony, an Ethernet system, or a wireless network, but is not exclusively limited to these. Optionally, it is still possible to control a single GVB device 1 by a cellular phone or in any other mentioned manner according to the first aspect of the present invention, in which case the command message could be sent directly to the GVB device 1 or indirectly through the HQ 6.

The GVB device 1 receives the command messages that initiate and control the generation of multimedia content to be displayed on the display device 2. In case of centralized usage, just as in the first aspect of the presented method, the GVB device 1 can mix the generated content with the input signal from the source 3, where that signal could be different for each one of the GVB devices 1.

In both aspects of the present invention, a command message consists of a header and a message body. It could be encrypted by using any known encryption algorithm with the purpose of preserving secrecy and authenticity.

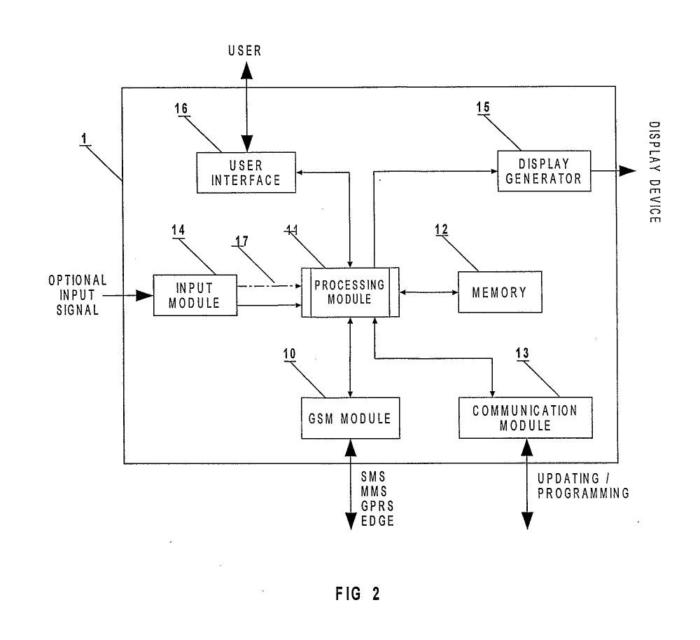

The functional representation of the GVB device is illustrated in FIG. 2. A communication GSM module 10 can receive command messages through the infrastructure of a mobile provider. If the command message is sent according to the second aspect of the present invention, it could also be received by a communication module 13. The module 13 can use the existing telecommunications infrastructure that includes the Internet, land line telephony, an Ethernet system, or a wireless network, but that is not exclusively limited to the above mentioned. The modules 10 and 13 are connected to a data processing module 11 which also controls and coordinates functioning of other modules as well as the whole device. The data processing module 11 is connected to a memory module 12 which is designed to store all data necessary for the proper functioning of the GVB device 1. The necessary data could be related to the system states, command messages, and messages for multimedia content generation. The memory module 12 could be a working memory unit such as random access memory (RAM), non-volatile RAM (NVRAM) etc., and/or a persistent memory unit (Flash memory, hard drive, magnetic tape, optical drive, etc.) that could be initially programmed or updated by using the modules 10, 13, and 14, completely or partially. A display generator 15, depending on the type of the display 5device 2, generates an adequate output signal, based on the information gathered from the data processing module 11. The generated signal on the output of the module 15 could be in the format of SVHS, composite, RGB, TV antenna, audio, VGA, DVI, or IEEE 1394 or a signal matched to command logic of LED or OLED display, but is not exclusively limited to these. The GVB device 1 has an input module 14, i.e., a decoder of an optional input signal from the source 3. It is active in case when an input signal is present on which, or over which, in partially or wholly, a new content generated by the module 11 is to be displayed, according to the functional description of the GVB device 1.

The optional input signal from the source 3 could be a modulated signal, a signal in a base spectrum, or a signal in the format of SVHS, composite, RGB, TV antenna signal, VGA, DVI, or IEEE 1394, but is not exclusively limited to these. The input module 14, besides having the input signal decoding function, has a possibility to detect and therefore generate a command signal 17 which is used to trigger the processing, generation and presentation of a specific multimedia content. Nevertheless, the input module 14 can generate the command signal 17 in regular intervals of time or in specific moments previously defined, independently of the input signal from the source 3, using an incorporated real time clock. A user interface module 16, i.e. a module for communication with the user provides direct interaction with the user in vicinity of the GVB device 1 for the purpose of a possible direct setup of the GVB device 1 functioning. This setup consists of turning the GVB device on/off, selecting the input signal type, selecting the type of the display device, and setting the parameters needed for overall proper functioning of the modules 10 and 13 and the GVB device 1. This setup can be also done centrally, through the command messages received via the communication modules 10 and 13, according to the second aspect of the present invention.

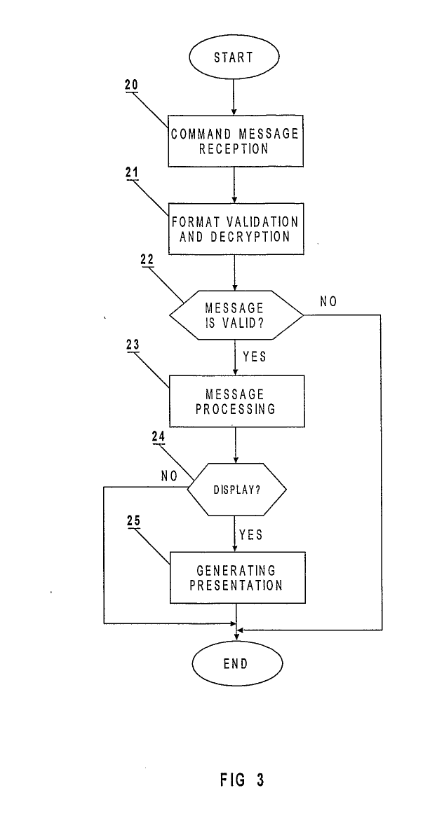

The activity block diagram as can be seen from FIG. 3 shows a GVB device 1 functioning in accordance with the first aspect of the present invention. At the beginning of the diagram, the GVB device 1 is in standby mode, expecting the reception of a command message. After the reception of the command message, in step 20, the message format is checked and the optional decryption is done in step 21. Depending on the result of step 21, in step 22 the decision is made if the received message is correct and if this is the case, the next step is step 23. If the message does not fulfill the necessary requirements, the GVB device 1 ignores it and returns to standby mode at the end of the block diagram, where it expects the reception of new command messages again. In step 23 the message is processed and filtered depending on its content and sender. If the requirements for the generation of representation of multimedia contents are fulfilled, which is decided in step 24, in step 25 presentation adjusted to the type of the display device is generated and the input signal from the source 3 is optionally used. If the requirements in step 24 are not fulfilled, the GVB device 1 returns to standby mode at the end of the block diagram, where it expects the reception of new command messages.

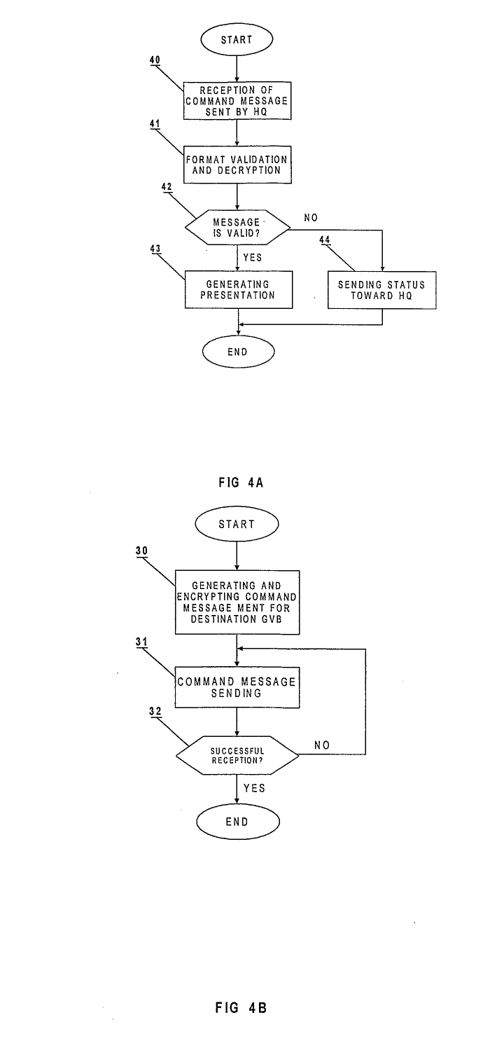

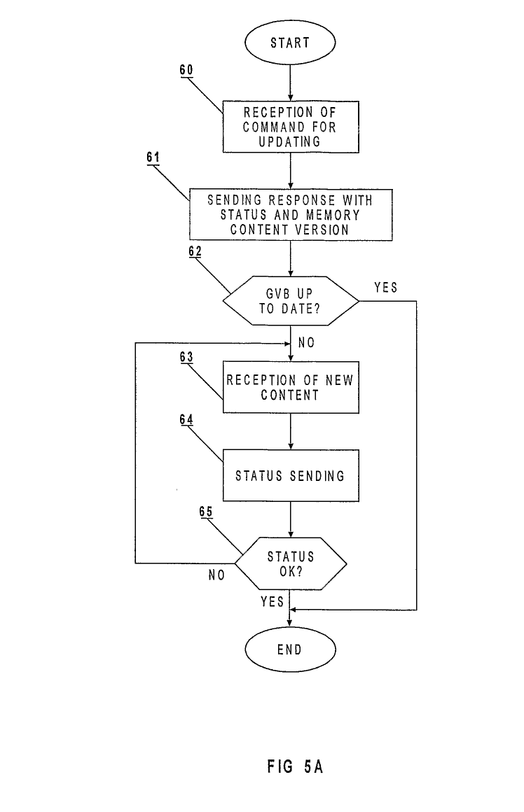

The activity block diagrams shown in FIG. 4A and FIG. 4B represent descriptions of the GVB device 1 and HQ 6 functioning in accordance with the second aspect of the present invention.

In FIG. 4A the activity block diagram for the GVB device, i.e. the functioning of the GVB device in accordance with the second aspect of the present invention is shown.

At the beginning of the diagram in FIG. 4A, the GVB device 1 is in standby mode, expecting the reception of a command message. After the reception of the command message, in step 40, the message format is checked and the optional decryption is done in step 41. Depending on the result of step 41, in step 42 the decision is made if the received message is correct and if this is the case, the next step is step 43. If the message does not fulfill the necessary requirements, the GVB device 1 sends a status message to the HQ 6 in step 44, and returns to standby mode at the end of the block diagram, where it expects the reception of new command messages. If the requirements for the generation of multimedia contents presentation are fulfilled, which is decided in step 42, in step 43 the presentation adjusted to the type of the display device is generated and the input signal from the source 3 is optionally used. After step 43, the GVB device 1 returns to standby mode at the end of the block diagram, where it expects the reception of new command messages.

The activity block diagram in FIG. 4B represents the system functioning from the perspective of the HQ 6. At the beginning of the diagram, the HQ 6 is in standby mode. In step 30 a command message for the destination GVB device 1 is generated and the optional content encryption is done. The command message generation is based upon the information received through the interaction with the user via the input device connected to the HQ 6 using the Internet, a mobile provider infrastructure, land line telephony, and similar connections. In step 31, the HQ 6 sends a prepared command message to the destination GVB device 1. Whether the message was successfully received by the GVB device 1, or not is checked in step 32. If necessary, the command message could be sent again in step 31 or otherwise the HQ 6 could return to standby mode at the end of the block diagram.

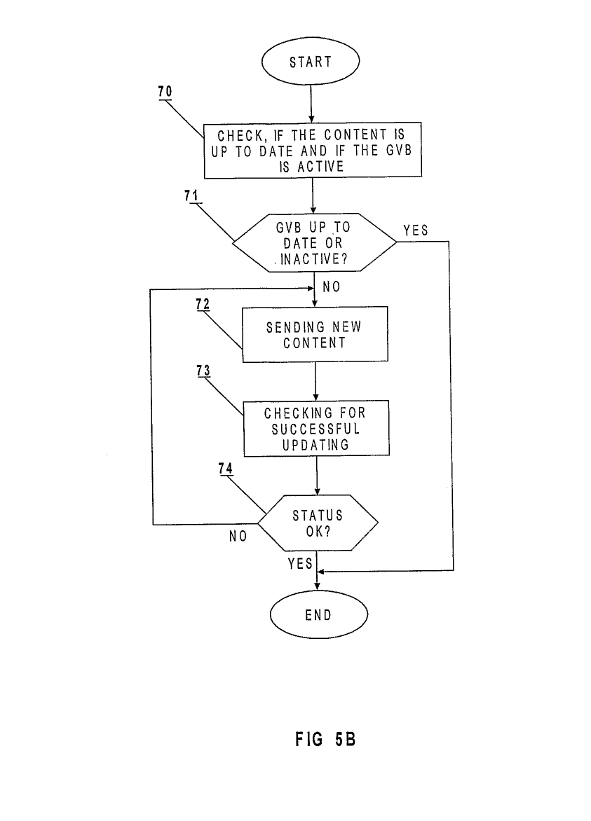

In FIG. 5A, the activity block diagram shows the GVB device 1 content updating process from the perspective of the GVB device 1. In step 60, the GVB device 1 receives the command message with the request for updating by the HQ 6. In step 61, the GVB device 1 sends a response with the information on its own status and the version of content from its own memory. Based on the received command message and version of the GVB device 1 content, in step 62 it is decided if the content will be updated. If the content is up to date, the GVB device 1 returns to standby mode at the end of the block diagram where it expects a new command message. If it is necessary to update, in step 63 the reception of new content is initiated. After the reception in step 64, the GVB device 1 sends its own status to the HQ 6. If the updating process is successful, the GVB device 1 returns to standby mode at the end of the block diagram, where it expects new command messages. In case of an unsuccessful updating process, the GVB device I goes to step 63, and waits for content retransmission.

In FIG. 5A, the activity block diagram shows the GVB device 1 content updating process from the perspective of the HQ 6. In step 70 the HQ 6 sends a command message in order to initiate the updating process of the destination GVB device 1. By means of the received response, the HQ 6 receives the information regarding the status and content version from the memory of the target GVB device 1. If the content is up to date, which is checked in step 71, transmission of new content is not necessary, so the HQ 6 returns to standby mode at the end of the block diagram. If the GVB device 1 content is not up to date, in step 72, new content is sent. After the sending is finished in step 73, the HQ 6 receives the message about status and a result of the updating process from the GVB device 1. Depending on the result of updating, in step 74 it is decided if the content should be retransmitted when the HQ 6 goes back to step 72, or if the updating process was successful when the HIQ 6 returns to standby mode at the end of the shown block diagram.

An implementation of the GVB device in smaller quantities, according to the present invention, could be done using the existing personal computer (PC) technology with appropriate modules for input signal processing, communication modules, display generator, and proper application software.

In case of large scale production, a grater scale of integration could be accomplished with the following implementations:
using multi-layer PCB design,
using general purpose CPU (x86) or microcontroller (e.g. Microchips PIC series, Intel),
using communication GSM modules such as modules by Sony Ericsson GM 47/48 or similar devices,
using a network interface (e.g. Realtek/Intel),
using an input signal module for case of TV signal, such as with BT878 or Cirrus Logic IC,
using a display generator (e.g. GPU Ati Radeon series),
using programmable logic such as a programmable logic device (PLD) for the purpose of glue logic and user interface, and
using an operating memory and memory storage for multimedia content (e.g. hard drive with necessary interface).

For the experts in the field it is obvious that various implementations of the present invention are not limited to the previous description and that they could vary within the scope defined by the following patent claims

1-31. (canceled)

32. A system for processing command messages and generation of multimedia content remotely controlled, the system comprising:
a. at least one GVB device (1) that decodes, receives and processes received command messages, based on which it generates multimedia content for the representation on a display device (2), where the GVB device (1) could be standalone or part of the display device (2), and could be uniquely identified on a telecommunications infrastructure (4);
b. at least one display device (2) used for the purpose of displaying content generated by the GVB device (1);
C. the existing telecommunications infrastructure (4) used for transmitting messages to and from the GVB device (1) and transferring the necessary information for memory content updating of the GVB device (1);
d. device (5) able to connect through the existing telecommunications infrastructure (4) with the purpose of sending command messages designed for the GVB device (1) or an HQ (6);
e. the HQ (6) being connected to the existing telecommunications infrastructure (4), in case where there is at least one GVB device (1) centrally controlled by the HQ (6); and
f. at least one input signal source (3) emitting signals to at least one GVB device (1) for the generation of multimedia content and memory content updating.

33. The system according to claim 32, wherein the multimedia content includes at least text, an image, a set of images, video material, a set of video materials, an audio recording, a set of audio recordings or any other combination of these elements.

34. The system according to claim 32, wherein the input signal emitted from the source (3) to the GVB device (1) is in a format selected from a modulated signal, a signal in base spectrum, an audio signal, an SVHS signal, a composite signal, an RGB signal, a TV antenna signal, a VGA signal, a DVI signal, and an IEEE 1394 signal.

35. The system according to claim 32, wherein the display device (2) is a device selected from a data projector, a video beam projector, a television (TV) set, a device for audio reproduction, a plasma screen, a monitor, a holographic display, a segmented display, a light emitting diode (LED) display, and an organic LED (OLED) display, wherein configuration of the display device (2) could be selected from standalone display or part of an advertising billboard display.

36. The system according to claim 32, wherein the telecommunications infrastructure (4) is selected from an infrastructure of mobile operator, the Internet, a land line telephony infrastructure, an Ethernet system, and a wireless network.

37. The system according to claim 32, wherein the GVB device (1) generates multimedia content independently, or mixes the multimedia content with the input signal from the source (3), or displays the multimedia content over the input signal from the source (3), where the generation and presentation of the multimedia content could be triggered by the received command message, the input signal, or an integrated real time clock.

38. The system according to claim 32, wherein the command messages are in a format selected from short message service (SMS) messages, enterprise messaging service (EMS) messages, multimedia messaging service (MMS) messages, and data packets sent over the telecommunications infrastructure by using known data transmission protocols, where the message includes a header and a body, which is not intended for displaying on the display device (2), and encrypted by using any known encryption algorithm with the purpose of preserving secrecy and authenticity.

39. The GVB device (1) according to claim 32, wherein it comprises the following parts:
a. communication GSM module (10) that is able to send and receive messages over the infrastructure of a mobile provider;
b. communication module (13) that is able to use the telecommunications infrastructure that could be the Internet, land line telephony, Ethernet, wireless network, but that is not exclusively limited to these, with the purpose of sending and receiving data packets using the existing data transmission protocols;
c. processing module (I 1) that controls and coordinates the functioning of other modules and device in whole, processes data from the memory module (12) and generates the necessary information for the display generator (15);
d. the memory module (12) designed to store all the necessary information needed for the functioning of the device and related to system states, command messages, and necessary data for multimedia content generation;
e. display generator (15), generates an adequate output signal depending on the type of the display device (2), based on the information gathered from the data processing module (11);
f. input module (14) which is a decoder of the input signal from the source (3); and
g. user interface module (16), that is a module for communication with the user, which provides direct interaction with the user in vicinity of the GVB device (1) with the purpose of possible direct setup of the functioning of the GVB device (1).

40. The GVB device (1) according to claim 39, wherein the memory module (12) is module selected from a working memory unit including random access memory (RAM) or non-volatile RAM (NVRAM), and/or a persistent memory unit including Flash memory, a hard drive, a magnetic tape, or an optical drive), where the module (12) is initially programmed or updated completely or partially by using the modules (10, 13 or 14).

41. The GVB device (1) according to claim 39, wherein the display generator (15) is able to generate a signal in a format including a SVHS signal, a composite signal, an RGB signal, a TV antenna signal, a VGA signal, a DVI signal, an IEEE 1394 signal, or a signal formatted to match command logic of an LED or OLED display.

42. The GVB device (I) according to claim 39, wherein the input module (14) is able to analyze the input signal from the source (3).

43. The GVB device (1) according to claim 39, wherein the GSM module (10) and communication module (13) are able to receive and send messages and data packets.

44. The GVB device (1) according to claim 39, wherein the GVB device (1) is able to decode, analyze and process received messages based on message content and sender.

45. The GVB device (1) according to claim 39, wherein the GVB device (1) is able to generate the output signal based on the content of the memory module (12).

46. The HQ (6) according to claim 32, further including one or more interconnected computers with application software, wherein the HQ (6) remotely controls a plurality of GVB devices (1) through the telecommunications infrastructure (4).

47. The HQ (6) according to claim 46, wherein the control of the plurality of the GVB devices (1) includes the steps of:
a. generating and sending messages to a destination GVB device (1);
b. content updating of the destination GVB device (1) at any time;
c. receiving the messages sent by the plurality of GVB devices (1) with information regarding device status, information regarding a version of content in the memory, and information regarding the input signal from the source (3);
d. receiving and processing the messages sent by Global System for Mobile communications (GSM) subscribers which have a visual contact with a particular display device (2) with the purpose of receiving the feedback information and statistical processing; and
e. setting up the destination GVB device (1) functioning parameters.

48. An HQ (6) according to claim 47, wherein the destination GVB device (1) includes one or more GVB devices (1) organized in groups of GVB devices.

49. An HQ (6) according to claim 47, wherein the content updating of the destination GVB device (1) includes checking a current version of memory content in the destination GVB device (1), and sending new content completely or partially.

50. An HQ (6) according to claim 47, wherein the information regarding the input signal from the source (3) includes the type and characteristics of the input signal, including a chosen frequency of a TV channel, and signal strength.

51. An HQ (6) according to claim 47, wherein the reception of the feedback information from GSM subscribers includes reception, analysis and statistical processing of the feedback information by the HQ (6).

52. A system according to claim 32, wherein when the device (5) also controls the GVB device (1).

53. A system according to claim 52, wherein the control operation of the GVB device (1), using the device (5) by sending messages, is performed by sending messages directly to the GVB device (1) or through the HQ (6).

54. A method for message processing and generation of multimedia content, the method comprising the steps of:
a. message reception format validation and message decryption, multimedia content generation for the purpose of presentation on a display device by a GVB device (1);
b. reception of the message sent by the HQ (6), including format validation and message decryption, multimedia content generation for the purpose of presentation on the display device by the GVB device (1), and when the received message is not valid, the GVB device (1) sends status to the HQ (6) and requests retransmission of the message;
c. generation, encryption and message sending by the HQ (6) to the destination GVB device (1), and if necessary, sending a new message to the GVB device (1),
d. performing an update, from the perspective of the GVB device (1), which includes the GVB device (1) performing reception of a message for updating from the HQ (6), when the GVB device (1) sends the information regarding status and memory content version, and if needed the GVB device (1) receives new content and stores the new content in a memory of the GVB device (1), and then sends a new status message, and the updating is repeated if there were errors during the updating, and
e. performing an update, from the perspective of the HQ (6), which includes performing a status and memory content version check of the GVB device (1), and depending on the received data, the HQ 96) performs an update by sending new content to the GVB device (1), and after the sending of the new content is finished, based on the received status of the GVB device (1), the HQ (6) checks whether the updating was successful or not, and repeats the step (e) of performing the update in case of an error.

55. A method according to claim 54, wherein message reception includes data reception of messages in a format selected from short message service (SMS) messages, enterprise messaging service (EMS) messages, multimedia messaging service (MMS) messages, and data packets by using the existing data transmission protocols, sent over the telecommunications infrastructure (4).

56. A method according to claim 54, wherein format validation and message decryption includes checking the message for correct syntax and sender authenticity.

57. A method according to claim 54, wherein the generation of multimedia content includes a process for preparing an output signal based on the message content and content of the memory module in the GVB device (1).

58. A method according to claim 54, wherein the presentation on the display device includes a process for projecting using reproduction of an output signal of the GVB device (1) adjusted for display by the display device (2).

59. A method according to claim 54, wherein the received message is not regarded as valid if the received message has an inadequate or unexpected format, had an inadequate sender, or if the decryption is unsuccessful.

60. A method according to claim 54, wherein the generation, encryption and message sending includes a process of message preparation according to an operation that the HQ (6) cause to initiate in the GVB device (1), and message encryption by using any known encryption algorithms with the purpose of preserving secrecy and authenticity, and sending the prepared and encrypted message.

61. A method according to claim 54, wherein the updating process represents data transmission over the telecommunications infrastructure (4) that changes the memory content of the GVB device (1).

62. A method according to claim 54, wherein the status and memory content version check includes a comparison of the current version of the memory content in the GVB device (1) with the desired content version.
